(19) United States
(12) Patent Application Publication
(10) Pub. No.: US 2026/0367332 A1
(43) Pub. Date: Nov. 19, 2026

(54) HOLDING SUBSTRATE, OPTICAL CONNECTION COMPONENT, AND METHOD OF MANUFACTURING HOLDING SUBSTRATE

(71) Applicant: SUMITOMO ELECTRIC INDUSTRIES, LTD., Osaka-shi, Osaka (JP)

(72) Inventor: Tsutaru KUMAGAI, Osaka-shi (JP)

(73) Assignee: SUMITOMO ELECTRIC INDUSTRIES, LTD., Osaka-shi, Osaka (JP)

(21) Appl. No.: 19/142,682

(22) PCT Filed: Nov. 22, 2023
(86) PCT No.: PCT/JP2023/042010

§ 371 Date: Jun. 24, 2025

(30) Foreign Application Priority Data
Dec. 26, 2022 (JP) 2022-208374

(51) Int. Cl. G02B 6/38

(52) U.S. Cl. CPC G02B 6/3855; G02B 6/3829

(57) ABSTRACT

A holding substrate holds a plurality of optical fibers. The holding substrate has at least one through-hole. Said at least one through-hole includes a plurality of insertion holes which extend in a first direction and into which the optical fibers are inserted in the first direction. Said at least one through-hole has a shape in which the insertion holes adjacent to each other in a second direction crossing the first direction are mutually connected as seen in the first direction. The insertion holes are arrayed in a line in the second direction.

### TECHNICAL FIELD

The present disclosure relates to a holding substrate, an optical connection component, and a method of manufacturing a holding substrate.

### BACKGROUND ART

A holding substrate that holds a plurality of optical fibers is known (for example, Patent literature 1 and Patent literature 2). The holding substrate has a plurality of insertion holes into which the plurality of optical fibers are inserted.

### CITATION LIST

### Patent Literature

Patent literature 1: WO 2020/027125
Patent literature 2: WO 2017/026072

### SUMMARY OF INVENTION

A holding substrate according to an embodiment of the present disclosure is configured to hold a plurality of optical fibers. The holding substrate has at least one through hole. The at least one through hole includes a plurality of insertion holes each extending in a first direction, the plurality of insertion holes being configured such that the plurality of optical fibers are inserted into the insertion holes in the first direction. The at least one through hole has a shape in which the plurality of insertion holes are connected in a second direction intersecting the first direction when viewed along the first direction. The plurality of insertion holes are arranged in a single row in the second direction.

An optical connection component according to an embodiment of the present disclosure includes a plurality of optical fibers and a holding substrate. The holding substrate is configured to hold a plurality of optical fibers. The holding substrate has at least one through hole. The at least one through hole includes a plurality of insertion holes each extending in a first direction, the plurality of insertion holes being configured such that the plurality of optical fibers are inserted into the insertion holes in the first direction. The at least one through hole has a shape in which the plurality of insertion holes are connected in a second direction intersecting the first direction when viewed along the first direction. The plurality of insertion holes are arranged in a single row in the second direction.

A method of manufacturing a holding substrate according to an embodiment of the present disclosure includes, preparing a substrate to be processed, and forming at least one through hole in the substrate to be processed by etching. The at least one through hole includes a plurality of insertion holes each extending in a first direction, the plurality of insertion holes being configured such that a plurality of optical fibers are inserted into the insertion holes in the first direction. The at least one through hole has a shape in which the plurality of insertion holes are connected in a second direction intersecting the first direction when viewed along the first direction. The plurality of insertion holes are arranged in a single row in the second direction.

### BRIEF DESCRIPTION OF THE DRAWINGS

FIG. 1 is a perspective view showing an example of an optical connection component in an embodiment.

FIG. 2 is an exploded perspective view of the optical connection component shown in FIG. 1.

FIG. 3 is a side view of the optical connection component shown in FIG. 1.

FIG. 4 is a perspective view of a holding substrate included in an optical connection component.

FIG. 5 is a plan view of a holding substrate.

FIG. 6 is a partially enlarged view of a holding substrate.

FIG. 7 is a cross-sectional view of a holding substrate.

FIG. 8 is a plan view of a holding substrate in a modification of the embodiment.

FIG. 9 is a perspective view of a holding substrate in a comparative example.

FIG. 10 is a view showing a method of applying an adhesive to a holding substrate in a comparative example.

FIG. 11 is a view showing a method of applying an adhesive to a holding substrate in the embodiment.

### DETAILED DESCRIPTION

In order to increase the amount of information to be transmitted, an increase in the number of optical fibers is considered. In contrast, there is a demand for reliable holding of each of the plurality of optical fibers and miniaturization of an optical connection component including the plurality of optical fibers.

An object of the present disclosure is to provide a holding substrate and an optical connection component that can achieve a high density arrangement of a plurality of optical fibers while each of the plurality of optical fibers is reliably held. It is an object to provide a method of manufacturing a holding substrate, which easily achieves a structure for achieving a high density arrangement of a plurality of optical fibers while each of the plurality of optical fibers is reliably held.

According to the present disclosure, a high density arrangement of a plurality of optical fibers is achieved while each of the plurality of optical fibers is reliably held.

### Description of Embodiments of Present Disclosure

First, the contents of embodiments of the present disclosure will be described by listing them individually.
(1) A holding substrate according to an embodiment of the present disclosure is configured to hold at least one optical fiber. The holding substrate has at least one through hole. The at least one through hole includes a plurality of insertion holes each extending in a first direction, the plurality of insertion holes being configured such that the plurality of optical fibers are inserted into the insertion holes in the first direction. The at least one through hole has a shape in which the plurality of insertion holes are connected in a second direction intersecting the first direction when viewed along the first direction. The plurality of insertion holes are arranged in a single row in the second direction.

In the holding substrate, each of the at least one through hole has a shape in which the plurality of insertion holes each extending in the first direction are connected in the second direction intersecting the first direction when viewed along the first direction.

The plurality of insertion holes are arranged in a single row in the second direction. In this case, a high density arrangement of the plurality of optical fibers is achieved while each of the plurality of optical fibers is reliably held.

(2) In the holding substrate according to the above (1), the holding substrate may have a plurality of through holes including the at least one through hole. When viewed along the first direction, the plurality of through holes may be arranged in a third direction intersecting both the first direction and the second direction.
(3) In the holding substrate according to the above (1) or (2), the plurality of insertion holes may include a first insertion hole, a second insertion hole, and a third insertion hole arranged in a single row in the second direction. When viewed along the first direction, the first insertion hole and the second insertion hole may be connected to each other in the second direction, and the second insertion hole and the third insertion hole may be connected to each other in the second direction. In this case, a higher density arrangement of the plurality of optical fibers is achieved while each of the plurality of optical fibers is reliably held.
(4) In the holding substrate according to any one of the above (1) to (3), each of the plurality of insertion holes may have a circular cross-sectional shape. In this case, a higher density arrangement of the plurality of optical fibers is achieved while each of the plurality of optical fibers is reliably held.
(5) In the holding substrate according to any one of the above (1) to (4), the at least one through hole may include a connection hole connecting insertion holes adjacent to each other among the plurality of insertion holes, and when a minimum width of the connection hole is “L4” in the third direction and a maximum width of each of the plurality of insertion holes is “L2,” a relationship below may be satisfied.
0<L4<0.75×L2
In this case, each of the plurality of optical fibers is more reliably held.
(6) An optical connection component according to an embodiment of the present disclosure includes a plurality of optical fibers and the holding substrate according to any one of the above (1) to (5) configured to hold the plurality of optical fibers. The plurality of optical fibers are inserted into the through hole in a state where the plurality of optical fibers are arranged in a single row in the second direction, and may be arranged in a plurality of rows extending from the through hole.

In this optical connection component, the through hole has a shape in which a plurality of insertion holes each extending in the first direction are connected in the second direction intersecting the first direction when viewed along the first direction. The plurality of insertion holes are arranged in a single row in the second direction. Thus, each of the plurality of optical fibers is reliably held. The plurality of optical fibers are inserted into the through hole in a state where the plurality of optical fibers are arranged in a single row in the second direction, and may be arranged in a plurality of rows extending from the through hole. In this case, the plurality of optical fibers arranged in a plurality of rows are inserted into the through hole in a state where the plurality of optical fibers are arranged in a single row. Thus, a high density arrangement of the plurality of optical fibers is achieved.
(7) In the optical connection component according to the above (6), each of the plurality of optical fibers may include a coated portion coated with a coating film, a curved portion exposed from the coated portion and curved, and a connected portion connected to the holding substrate. In each of the plurality of optical fibers, the coated portion, the curved portion, and the connected portion may be arranged sequentially. As the coated portion is wider, flaws due to contact between the plurality of optical fibers are suppressed. On the other hand, in order to form the curved portion, it is considered to curve the optical fiber by heating. In this case, if the curved portion is coated with the coating film, the coating film may melt. According to the above-described configuration, the curved portion is easily formed while suppressing flaws due to contact between the plurality of optical fibers.
(8) A method of manufacturing a holding substrate according to an embodiment of the present disclosure includes preparing a substrate to be processed, and forming at least one through hole, into which the plurality of optical fibers are inserted, in the substrate to be processed by etching. The at least one through hole includes a plurality of insertion holes each extending in a first direction, the plurality of insertion holes being configured such that a plurality of optical fibers are inserted into the insertion holes in the first direction. The at least one through hole has a shape in which the plurality of insertion holes are connected in a second direction intersecting the first direction when viewed along the first direction. The plurality of insertion holes are arranged in a single row in the second direction.

In the method of manufacturing the holding substrate, at least one through hole into which the plurality of optical fibers are inserted is formed in the substrate to be processed by etching. The at least one through hole has a shape in which the plurality of insertion holes each extending in the first direction are connected in the second direction intersecting the first direction when viewed from the first direction. The plurality of insertion holes are arranged in a single row in the second direction. In this case, a structure for achieving a high density arrangement of a plurality of optical fibers while each of the plurality of optical fibers is reliably held is easily achieved.

### Details of Embodiments of Present Disclosure

Specific examples of embodiments of the present disclosure will be described below with reference to the drawings. The present invention is not limited to these examples, but is defined by the scope of the claims, and is intended to include all modifications within the meaning and scope equivalent to the scope of the claims. In the description of the drawings, the same elements are denoted by the same reference numerals, and redundant description will be omitted.

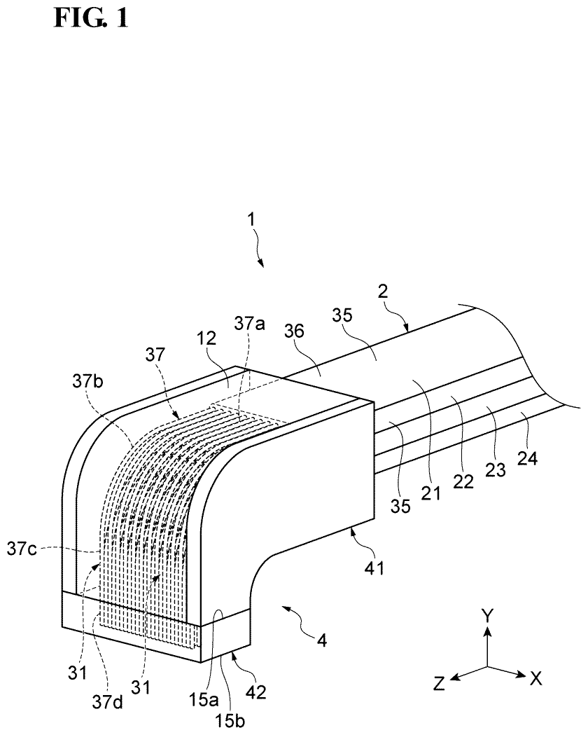

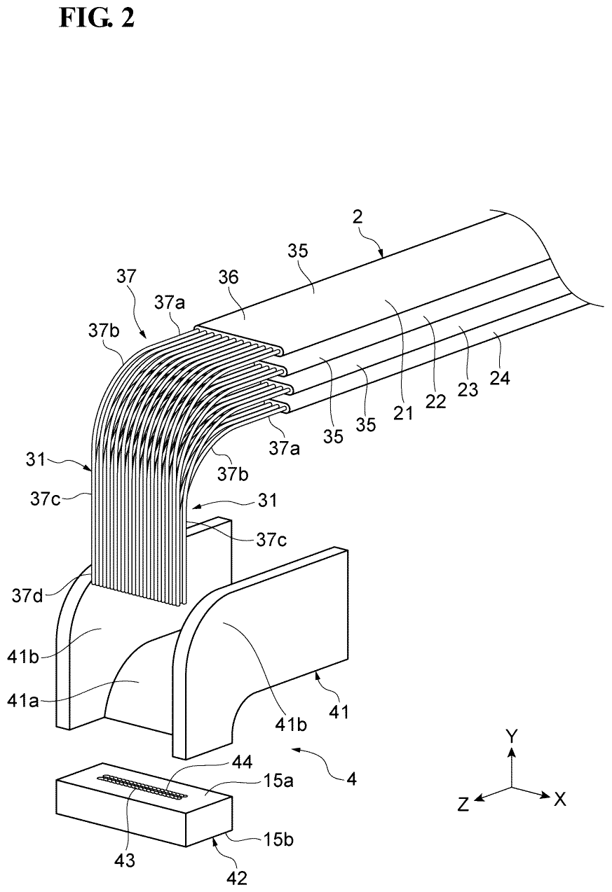

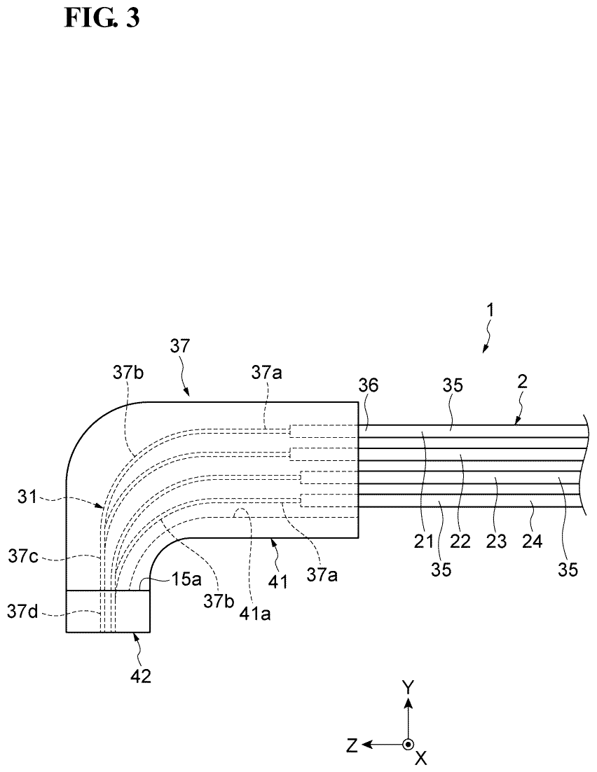

FIG. 1 is a perspective view showing an example of an optical connection component in an embodiment. FIG. 2 is an exploded perspective view of the optical connection component shown in FIG. 1. FIG. 3 is a side view of the optical connection component shown in FIG. 1. An optical connection component 1 includes a fiber ribbon 2 and a fiber fixing component 4. The optical connection component 1 includes, for example, a plurality of fiber ribbons 2. The plurality of fiber ribbons 2 include, for example, fiber ribbons 21, 22, 23, 24. The optical connection component 1 may include only one fiber ribbon 2.

Each of the fiber ribbons 21, 22, 23, 24 has a curved portion in the middle, and a first end of each of the fiber ribbons 21, 22, 23, 24 is fixed to the electronic substrate via a holding substrate 42, and a second end of each of the fiber ribbons 21, 22, 23, 24 is connected to the in-house wiring via a connector (not shown).

Each of the fiber ribbons 21, 22, 23, 24 includes a plurality of optical fibers 31 arranged along the X-axis direction. The optical fiber 31 is, for example, a glass fiber. The optical fiber 31 has an outer diameter of, for example, 125 μm. The optical fiber 31 is a single-core optical fiber having a single core. The optical fiber 31 may be a multi-core optical fiber including a glass fiber having a plurality of cores.

Each of the plurality of optical fibers 31 includes a coated portion 36 coated with a coating film 35 and a exposed portion 37 exposed from the coating film 35. The exposed portion 37 includes a linear portion 37a, a curved portion 37b, a linear portion 37c, and a connected portion 37d. The linear portion 37a extends from the coating film 35 in the Z-axis direction, for example. The curved portion 37b is connected to the linear portion 37a, curved from the linear portion 37a, and connected to the linear portion 37c. The linear portion 37c extends from the curved portion 37b in the Y-axis direction. The connected portion 37d extends from the linear portion 37c in the Y-axis direction and is connected to the fiber fixing component 4. In each of the plurality of optical fibers 31, the coated portion 36, the curved portion 37b, and the connected portion 37d are arranged sequentially. For example, the curved portion 37b is curved by heating of the optical fiber 31.

The fiber fixing component 4 includes a resin ferrule 41 and the holding substrate 42. As shown in FIGS. 1 to 3, the resin ferrule 41 has a substantially L-shape in a side surface view, and is placed on the holding substrate 42. The resin ferrule 41 includes a front surface 41a as shown in FIG. 2.

The linear portions 37a, the curved portions 37b, and the linear portions 37c of the plurality of optical fibers 31 are arranged along the front surface 41a. The resin ferrule 41 includes side surfaces 41b which are respectively opposed to the side ends of the fiber ribbons 21, 22, 23, 24 on the sides of the front surface 41a. The resin ferrule 41 includes a resin portion 12 covering the optical fiber 31. The resin portion 12 contains, for example, an acrylic resin, an epoxy resin, or silicone as a material.

The resin ferrule 41 contains, for example, metal, engineering plastic, or the like as a material. Examples of the metal include stainless steel. Examples of the engineering plastic includes polyphenylene sulfide, liquid crystal polymer, or the like.

The resin ferrule 41 may have a shape other than the substantially L-shape. For example, the resin ferrule 41 may have a shape applicable to a linear optical fiber that is not bent.

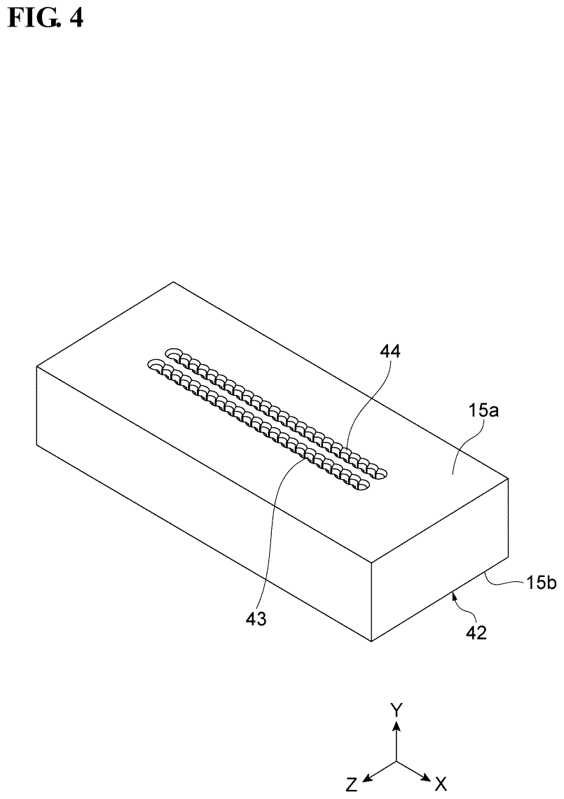

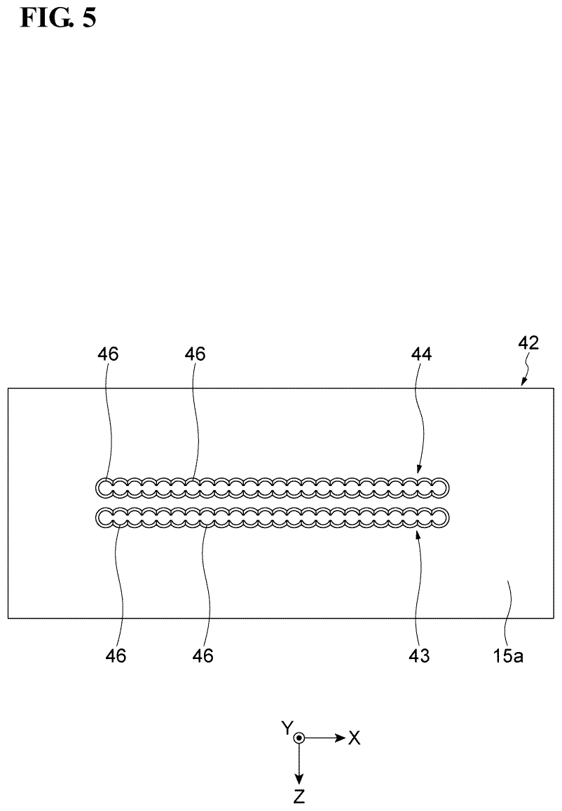

The holding substrate 42 is, for example, a glass substrate. The glass substrate contains, for example, fused silica glass, borosilicate glass, or the like as a material. As shown in FIGS. 4 and 5, the holding substrate 42 includes a glass plate having a rectangular parallelepiped shape, for example. For example, ultraviolet rays are capable of transmitting the holding substrate 42, and a front surface 15a having a rectangular shape is disposed to face the resin ferrule 41, and likewise, a rear surface 15b having a rectangular shape is disposed to face the electronic substrate. The rear surface 15b is fixed to the electronic substrate by using a UV adhesive. Here, the phrase “ultraviolet rays are capable of transmitting the holding substrate 42” means that, for example, the transmissivity of the holding substrate 42 having a thickness of 1 mm is 10% or more when the holding substrate 42 is irradiated with ultraviolet rays having wavelengths of 350 nm to 400 nm. The holding substrate 42 may be, for example, a silicon substrate. When the holding substrate 42 is opaque to ultraviolet light, the holding substrate 42 may be fixed to the electronic substrate by a thermosetting adhesive.

As shown in FIGS. 4 and 5, the holding substrate 42 has at least one through hole 43 or 44. In the example shown in the embodiment, the holding substrate 42 has the plurality of through holes 43, 44. The holding substrate 42 may have only one through hole 43. The connected portion 37d is connected to the holding substrate 42.

The through holes 43, 44 extend in the thickness direction (first direction) of the holding substrate 42 and penetrate the holding substrate 42. The thickness between the front surface 15a and the rear surface 15b of the holding substrate 42 is thin, for example, about 1 mm. The through holes 43, 44 penetrate the front surface 15a and the rear surface 15b. The through holes 43, 44 extend in a direction (second direction) intersecting the thickness direction of the holding substrate 42.

The thickness direction of the holding substrate 42 corresponds to the Y-axis direction, and the direction intersecting the thickness direction of the holding substrate 42 corresponds to the X-axis direction. In the example shown in the embodiment, the plurality of through holes 43, 44 are arranged in the Z-axis direction intersecting both the Y-axis direction and the X-axis direction when viewed along the Y-axis direction. The Y-axis direction corresponds to a first direction D1, the X-axis direction corresponds to a second direction D2, and the Z-axis direction corresponds to a third direction D3.

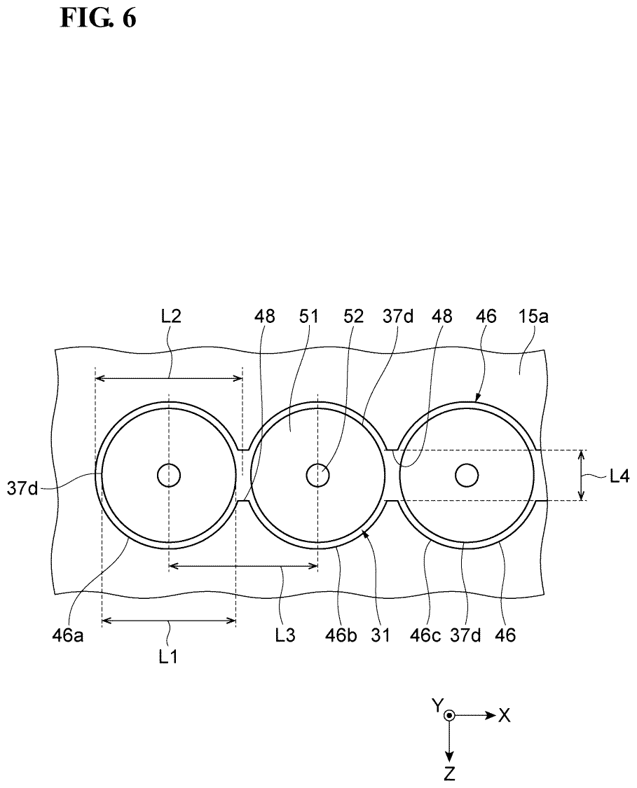

Each of the through holes 43, 44 includes a plurality of insertion holes 46 into which the connected portions 37d of the plurality of optical fibers 31 are inserted. As shown in FIG. 6, each of the plurality of optical fibers 31 includes a cladding 51 and a core 52. The cladding 51 and the core 52 each contain silica-based glass. The plurality of optical fibers 31 are inserted into the corresponding insertion holes 46 among the plurality of insertion holes 46 and fixed by an adhesive. The adhesive contains, for example, an epoxy resin, an acrylic resin, or silicone as a material.

The plurality of insertion holes 46 extend in the Y-axis direction. The plurality of insertion holes 46 penetrate the front surface 15a and the rear surface 15b. The plurality of insertion holes 46 are arranged in a single row in the X-axis direction. Each of the through holes 43, 44 has a shape in which the plurality of insertion holes 46 are connected in the X-axis direction. The plurality of insertion holes 46 include a first insertion hole 46a, a second insertion hole 46b, and a third insertion hole 46c arranged in order in the X-axis direction. When viewed along the Y-axis direction, the first insertion hole 46a and the second insertion hole 46b are connected to each other in the X-axis direction, and the second insertion hole 46b and the third insertion hole 46c are connected to each other in the X-axis direction.

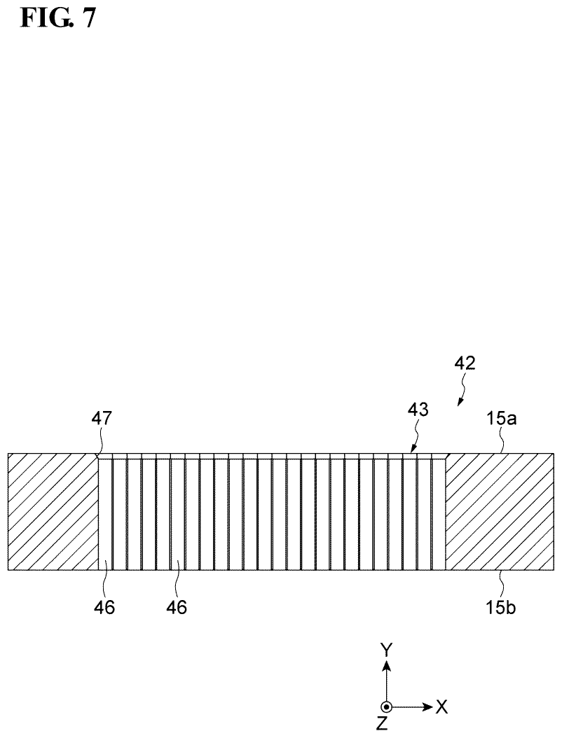

As shown in FIG. 7, the holding substrate 42 includes an inclined surface 47 which connects the edges of the plurality of insertion holes 46 and the front surface 15a and is inclined with respect to the Y-axis direction. The inclined surface 47 is widened from the insertion hole 46 toward the front surface 15a.

Each of the through holes 43, 44 includes a connection hole 48 connecting the insertion holes 46 adjacent to each other. Each of the through holes 43, 44 has a shape in which the plurality of insertion holes 46 are connected to each other in the X-axis direction via the connection holes 48. The plurality of connection holes 48 extend in the Y-axis direction. The plurality of connection holes 48 penetrate the front surface 15a and the rear surface 15b.

Each of the plurality of insertion holes 46 has a circular cross-sectional shape. When the outer diameter of the optical fiber 31 is “L1”, the diameter of each of the plurality of insertion holes 46 is “L2”, and the pitch between the insertion holes 46 adjacent to each other in the X-axis direction is “L3”, expression (1) L1≤L2 and expression (2) L1≤L3<2×L1 are satisfied. When the expression (3) L1≤L2<L1+0.002 mm is satisfied, the positioning accuracy of the connected portion 37d of the optical fiber 31 inserted into the insertion hole 46 is further improved. When the expression (4) L1≤L2<L1+0.001 mm is satisfied, the positioning accuracy of the connected portion 37d of the optical fiber 31 inserted into the insertion hole 46 is further improved. For example, the outer diameter “L1” of the optical fiber 31 is 125 μm, and the pitch “L3” between the insertion holes 46 adjacent to each other in the X-axis direction is 127 μm.

When the minimum width of the connection hole 48 in the X-axis direction is “L4”, the expression (5) 0<L4<L2 is satisfied. When the expression (6) L4<0.75×L2 is satisfied, the positioning accuracy of the connected portion 37d of the optical fiber 31 inserted into the insertion hole 46 is further improved. When the expression (7) L4<0.5×L2 is satisfied, the positioning accuracy of the connected portion 37d of the optical fiber 31 inserted into the insertion hole 46 is further improved.

The through holes 43, 44 may be formed by, for example, a process in which photolithography and dry etching such as reactive ion etching (RIE) are combined, or a hole forming technique using a laser. In the embodiment, the through holes 43, 44 are formed by laser irradiation and etching. For example, a part of the substrate to be processed is modified by laser irradiation, and the modified part is removed by etching. As a result, the through holes 43, 44 are formed. In this case, for example, the substrate to be processed is borosilicate glass. The part modified by the laser irradiation is removed by etching.

When ultraviolet rays are capable of transmits the holding substrate 42, for example, the holding substrate 42 is fixed to an optical integrated circuit such as Si-PIC using a UV adhesive. Here, the phrase “ultraviolet rays are capable of transmitting the holding substrate 42” means that, for example, the transmissivity of a material having a thickness of 1 mm is 10% or more when the material is irradiated with ultraviolet rays having wavelengths of 350 nm to 400 nm. When ultraviolet rays do not transmit the holding substrate 42, for example, the holding substrate 42 may be fixed to the optical integrated circuit using a thermosetting adhesive.

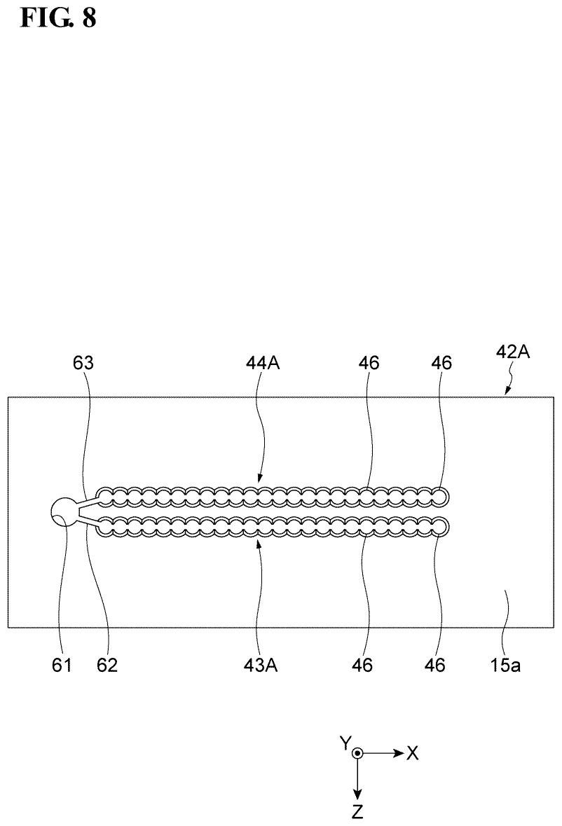

Next, with reference to FIG. 8, the optical connection component in a modification of the embodiment will be described. FIG. 8 is a plan view of a holding substrate in a modification. The modification is generally similar or identical to the embodiment described above. The modification is different from the above-described embodiment in that a plurality of through holes are connected in the holding substrate.

Hereinafter, differences between the above-described embodiment and the modification will be mainly described.

As shown in FIG. 8, in the modification, the optical connection component 1 includes a holding substrate 42A. The holding substrate 42A has a plurality of through holes 43A, 44A. The through holes 43A, 44A extend in the thickness direction of the holding substrate 42A and penetrate the holding substrate 42A. The through holes 43A, 44A penetrate the front surface 15a and the rear surface 15b. The through holes 43A, 44A extend in a direction intersecting the thickness direction of the holding substrate 42A.

The thickness direction of the holding substrate 42A corresponds to the Y-axis direction, and the direction intersecting the thickness direction of the holding substrate 42A corresponds to the X-axis direction. In the example shown in the embodiment, the plurality of through holes 43A, 44A are arranged in the Z-axis direction intersecting the Y-axis direction and the X-axis direction when viewed along the Y-axis direction.

The through hole 43A and the through hole 44A are connected to each other. For example, the holding substrate 42A includes connection holes 61, 62, 63 that connect the through hole 43A and the through hole 44A. The connection holes 61, 62, 63 extends in the Y-axis direction. The connection holes 61, 62, 63 penetrate the front surface 15a and the rear surface 15b. The connection hole 61 has a circular cross-sectional shape when viewed along the Y-axis direction. The connection hole 61 is connected to the through hole 43A by the connection hole 62. The connection hole 61 is connected to the through hole 44A by the connection hole 63. In this modification, the connection holes 61, 62, 63 are disposed at positions not overlapping the through hole 43A and the through hole 44A when viewed along the Y-axis direction.

As a further modification of the present modification, the connection holes 61, 62, 63 may be disposed at positions overlapping the through hole 43A and the through hole 44A when viewed along the Y-axis direction. In this case, the connection holes 61, 62, 63 may be disposed between the through hole 43A and the through hole 44A.

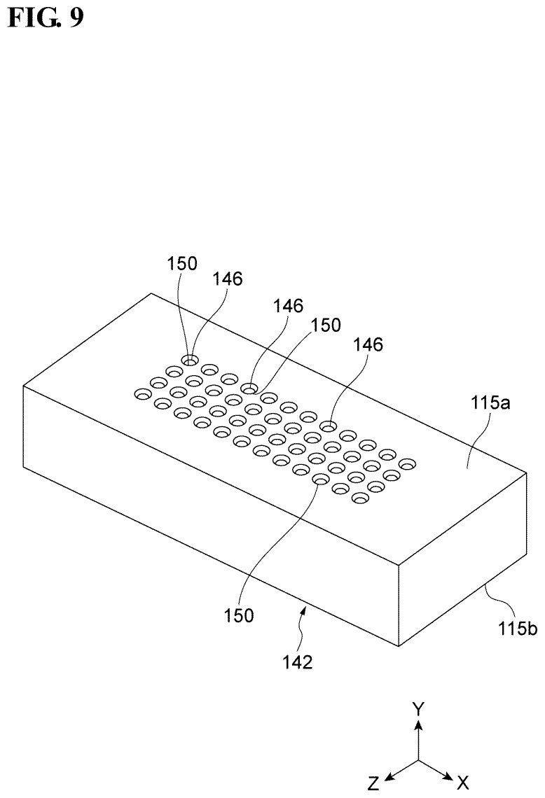

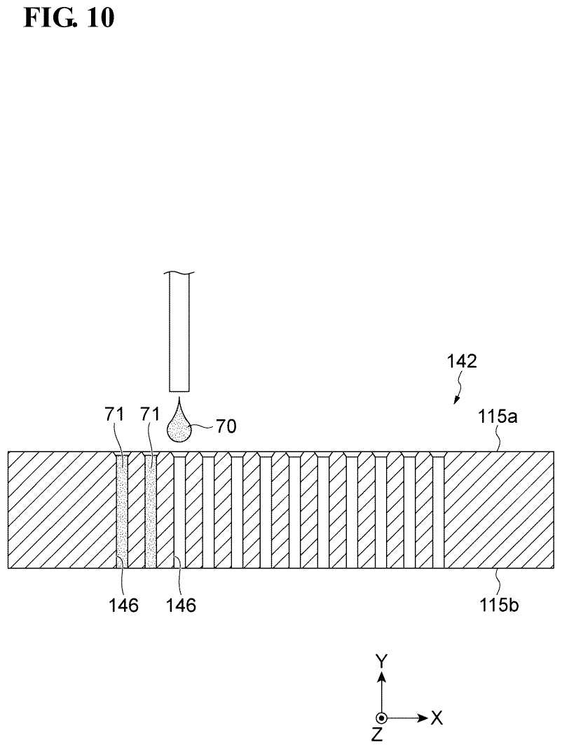

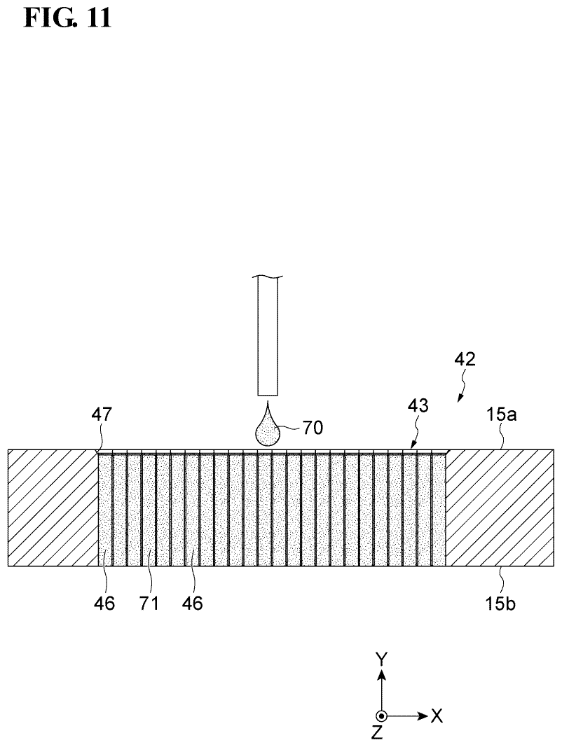

Next, the effects of the holding substrate 42, the optical connection component 1, and the method of manufacturing the holding substrate 42 will be described with reference to FIGS. 9 to 11. FIG. 9 is a perspective view of a holding substrate in a comparative example. FIG. 10 is a view showing a method of applying an adhesive to a holding substrate in a comparative example. FIG. 11 is a view showing a method of applying an adhesive to a holding substrate in the embodiment.

In a holding substrate 142 shown in FIG. 9, a plurality of through holes 150 are arranged in a two dimensional manner when viewed along the Y-axis direction. The plurality of through holes 150 are spaced apart from each other. Each of the plurality of through holes 150 includes an insertion hole 146 into which an optical fiber is inserted. Only one insertion hole 146 is provided for each through hole 150. In this case, each of the through holes 150 and the insertion holes 146 penetrates from a front surface 115a to a rear surface 115b. In this case, since the through holes 150 adjacent to each other are spaced apart from each other, it is difficult to improve the density of the insertion holes 146 adjacent to each other. Further, as shown in FIG. 10, when an adhesive 70 is applied, the adhesive 70 is applied to each insertion hole 146, and thus, production efficiency may be reduced.

On the other hand, in the holding substrate 42 of the embodiment, each of the plurality of through holes 43, 44 has a shape in which the plurality of insertion holes 46 each extending in the Y-axis direction are connected in the X-axis direction when viewed along the Y-axis direction. The plurality of insertion holes 46 are arranged in a single row in the X-axis direction. The plurality of through holes 43, 44 are arranged in the Z-axis direction when viewed along the Y-axis direction. In this case, a high density arrangement of the plurality of optical fibers is achieved while each of the plurality of optical fibers 31 are reliably held.

The plurality of optical fibers 31 are inserted into the through hole 43 in a state where the plurality of optical fibers 31 arranged in a single row in the X-axis direction, and are arranged in a plurality of rows extending from the through hole 43. For example, four rows of fiber ribbons 21, 22, 23, 24 are arranged. In this case, the plurality of optical fibers 31 arranged in a plurality of rows are inserted into the through hole 43 in a state of being arranged in a single row. Thus, a high density arrangement of the plurality of optical fibers is achieved.

In the method of manufacturing the holding substrate 42, the plurality of insertion holes 46 into which the plurality of optical fibers 31 are inserted are formed in the substrate to be processed by etching. In this case, as shown in FIG. 11, the adhesive 70 is applied to the plurality of insertion holes 46 by one application of the adhesive 70. For example, even if the driving amount of the nozzle for applying the adhesive 70 is small and the driving accuracy of the nozzle is low, the adhesive 70 is applied to the plurality of insertion holes 46 included in the through hole 43. In this case, a structure for achieving a high density arrangement of the plurality of optical fibers 31 while each of the plurality of optical fibers 31 is reliably held is easily achieved.

The plurality of insertion holes 46a, 46b, 46c are arranged in a single row in the X-axis direction. When viewed along the Y-axis direction, the insertion hole 46a and the insertion hole 46b may be connected to each other in the X-axis direction, and the insertion hole 46b and the insertion hole 46c may be connected to each other in the X-axis direction. In this case, a higher density arrangement of the plurality of optical fibers is achieved while each of the plurality of optical fibers 31 are reliably held.

Each of the plurality of insertion holes 46 may have a circular cross-sectional shape. In this case, a higher density arrangement of the plurality of optical fibers is achieved while each of the plurality of optical fibers 31 are reliably held.

When a minimum width of a portion at which the plurality of insertion holes 46 adjacent to each other are connected to each other is “L4” in the Z-axis direction, and a maximum width of each of the plurality of insertion holes 46 is “L2”, a relationship below may be satisfied.
0<L4<0.75×L2
In this case, each of the plurality of optical fibers 31 is more reliably held.

Each of the plurality of optical fibers 31 may include the coated portion 36 coated with the coating film 35, the curved portion 37b exposed from the coated portion 36 and curved, and the connected portion 37d connected to the holding substrate 42. In each of the plurality of optical fibers 31, the coated portion 36, the curved portion 37b, and the connected portion 37d may be arranged sequentially. As the coated portion 36 is wider, flaws due to contact between the plurality of optical fibers 31 are suppressed. On the other hand, in order to form the curved portion 37b, it is considered to curve the optical fiber 31 by heating. In this case, if the curved portion 37b is coated with the coating film 35, the coating film 35 may melt. According to the above-described configuration, the curved portion 37b is easily formed while suppressing flaws due to contact between the plurality of optical fibers 31.

Although the embodiments of the present disclosure have been described in detail, the present disclosure is not limited to the above-described embodiments, and can be applied to various embodiments. For example, although the embodiment in which the two through holes 43, 44 are arranged in the Z-axis direction when viewed along the Y-axis direction has been described, three or more through holes may be arranged in the Z-axis direction when viewed along the Y-axis direction.

### REFERENCE SIGNS LIST

1 optical connection component
2 fiber ribbon
4 fiber fixing component
12 resin portion
15a front surface
15b rear surface
21 fiber ribbon
22 fiber ribbon
23 fiber ribbon
24 fiber ribbon
31 optical fiber
35 coating film
36 coated portion
37 exposed portion
37a linear portion
37b curved portion
37c linear portion
37d connected portion
41 resin ferrule
41a front surface
41b side surface
42 holding substrate
42A holding substrate
43 through hole
43A through hole
44 through hole
44A through hole
46 insertion hole
46a first insertion hole
46b second insertion hole
46c third insertion hole
47 inclined surface
48 connection hole
51 cladding
52 core
61 connection hole
62 connection hole
63 connection hole
70 adhesive
115a front surface
115b rear surface
142 holding substrate
146 insertion hole
150 through hole
D1 first direction
D2 second direction
D3 third direction

1. A holding substrate configured to hold a plurality of optical fibers,
wherein the holding substrate has at least one through hole,
wherein the at least one through hole includes a plurality of insertion holes each extending in a first direction, the plurality of insertion holes being configured such that the plurality of optical fibers are inserted into the insertion holes in the first direction,
wherein the at least one through hole has a shape in which the plurality of insertion holes are connected in a second direction intersecting the first direction when viewed along the first direction, and
wherein the plurality of insertion holes are arranged in a single row in the second direction.

2. The holding substrate according to claim 1,
wherein the holding substrate has a plurality of through holes including the at least one through hole, and
wherein, when viewed along the first direction, the plurality of through holes are arranged in a third direction intersecting both the first direction and the second direction.

3. The holding substrate according to claim 1,
wherein the plurality of insertion holes include a first insertion hole, a second insertion hole, and a third insertion hole arranged in a single row in the second direction, and
wherein, when viewed along the first direction, the first insertion hole and the second insertion hole are connected to each other in the second direction, and the second insertion hole and the third insertion hole are connected to each other in the second direction.

414. The holding substrate according to claim 1,
wherein each of the plurality of insertion holes has a circular cross-sectional shape.

5. The holding substrate according to claim 2,
wherein, the at least one through hole includes a connection hole connecting insertion holes adjacent to each other among the plurality of insertion holes, and
when a minimum width of the connection hole is “L4” in the third direction and a maximum width of each of the plurality of insertion holes is “L2,” a relationship below is satisfied.
0<L4<0.75×L2

6. An optical connection component comprising:
a plurality of optical fibers; and
the holding substrate according to claim 1 configured to hold the plurality of optical fibers,
wherein the plurality of optical fibers are inserted into the through hole in a state where the plurality of optical fibers are arranged in a single row in the second direction.

7. The optical connection component according to claim 6,
wherein each of the plurality of optical fibers includes a coated portion coated with a coating film, a curved portion exposed from the coated portion and curved, and a connected portion connected to the holding substrate, and
wherein, in each of the plurality of optical fibers, the coated portion, the curved portion, and the connected portion are arranged sequentially.

8. A method of manufacturing a holding substrate, the method comprising:
preparing a substrate to be processed; and
forming at least one through hole in the substrate to be processed by etching,
wherein the at least one through hole includes a plurality of insertion holes each extending in a first direction, the plurality of insertion holes being configured such that a plurality of optical fibers are inserted into the insertion holes in the first direction,
wherein the at least one through hole has a shape in which the plurality of insertion holes are connected in a second direction intersecting the first direction when viewed along the first direction, and
wherein the plurality of insertion holes are arranged in a single row in the second direction.
